(19) United States
(12) Patent Application Publication
(10) Pub. No.: US 2021/0356594 A1
(43) Pub. Date: Nov. 18, 2021

(54) PASSING RECOGNITION SYSTEM AND METHOD FOR NON-CONTACT MONITORING

(71) Applicant: Kaba Gallenschütz GmbH, Bühl (DE)

(72) Inventors: Gerald DROLL, Bühl (DE); Arno VOLLMER, Achern (DE)

(21) Appl. No.: 17/317,297

(22) Filed: May 11, 2021

(30) Foreign Application Priority Data
May 14, 2020 (DE) 10 2020 113 114.3

(51) Int. Cl. G01S 17/50; G06K 9/00

(52) U.S. Cl. CPC G01S 17/50; G06K 9/00335

(57) ABSTRACT

A passing recognition system for non-contact monitoring of a passing area includes at least one housing, a floor edge, in particular for installing on a floor of the passing area, and with a head sensor for detecting a detection area. Furthermore, the a method for non-contact monitoring as well as a computer-implemented method for performing the method includes related features.

### CROSS-REFERENCE TO RELATED APPLICATIONS

This application claims priority to German Patent Application No. 10 2020 113 114.3, filed on May 14, 2020, the contents of which are hereby incorporated by reference in their entirety.

### TECHNICAL FIELD

The present disclosure relates to a passing recognition system for non-contact monitoring of a passing area with at least one housing, a floor edge, in particular for installing on a floor of the passing area, and with a head sensor for detecting a detection area.

### BACKGROUND

Such passing recognition systems are known in the state-of-the-art. The known solutions are disadvantageous in that, for reliable monitoring, the passing recognition system requires having a high extension and/or in that monitoring is not reliable enough.

### SUMMARY

The present disclosure overcomes the existing disadvantages, at least partially. In particular, it is the present disclosure that provides a passing recognition system and/or a method, wherein the passing recognition system allows for reliable monitoring, in particular at low height of the passing recognition system.

This is achieved with the independent claim 1. Advantageous further developments of the passing recognition system are indicated in the dependent claims, the description and the Figures. Furthermore, the advantage is achieved with a method according to claim 11 and/or a computer-implemented method according to claim 15. Advantageous further developments of the computer-implemented method and of the passing recognition system are indicated in the dependent claims, the description and the Figures.

Features and details, which are described in conjunction with the inventive passing recognition system, are in this case also valid in conjunction with the inventive method and the inventive computer-implemented method and vice versa. In this case, the features mentioned in the description and in the claims can be essential to the disclosure, respectively individually on their own or in combination.

In particular, a passing recognition system is protected, in which the inventive method, in particular the method according to any of the claims 11 to 15 is executable, as well as a method, which can be executed with a passing recognition system according to any of the claims 1 to 10.

Particularly advantageously indicated in a passing recognition system for non-contact monitoring of a passing area with at least one housing, a floor edge, in particular for installing on a floor of the passing area, and with a head sensor for detecting a detection area, is that the detection area of the head sensor is located above the housing.

In other words, the detection area is at a height above the height of the housing starting at a floor edge of the passing recognition system. In other words, the head sensor is formed and/or disposed such that the detection area thereof detects above the highest point of the housing starting at the floor edge of the passing recognition system. Thereby is meant that the detection area of the head sensor is located above a virtual horizontal plane, wherein the plane comprises the highest point of the housing. When arranging several housings, in particular for delimiting the passing area, the detection area can be located above the one housing or above the several housings.

In this case, the floor edge of the passing recognition system denotes the lowest point of the passing recognition system, wherein the lowest point is on the floor of the passing recognition system. In particular, the floor edge can be the lowest point of an installation foot of the housing.

A component is understood as the housing, which can house one or more elements of the passing recognition system. However, the housing does not necessarily have to be terminated to the outside, but rather can comprise at least one or more openings and/or cut-outs.

In this case in particular, the housing can be formed as a guide element, in particular for guiding through individuals through the passing area. In particular, the housing can be delimited to the top by a handrail as the upper housing part.

Thereby, by means of a passing recognition system having a low height, enabling to detect motion data above the housing of the passing recognition system. Thereby being able to improve monitoring, in particular in that the inventive passing recognition system is able to detect motion data, which usually just individuals cause.

In particular, the detection area of the head sensor can be at a height between 1000 mm to 2200 mm, in particular 1100 mm to 2100 mm, in particular 1150 mm to 2000 mm, in particular 1200 mm to 1900 mm, in particular 1250 mm to 1800 mm, in particular 1300 mm to 1700 mm, in particular 1350 mm to 1600 mm, in particular 1400 mm to 1500 mm, starting at the floor edge of the passing recognition system. In particular, the detection direction of the head sensor can be oriented obliquely upwards.

For detecting, the head sensor can have at least one source and at least one receiver and/or detect the detection area thereof by reflexion. In particular, the head sensor can be formed as an optical and/or opto-electronical and/or photo-electric sensor. In particular in this case, cameras, in particular photo cameras and/or video cameras, can be excluded as sensors. In particular, the head sensor can be formed as a light barrier and/or one-way light barrier and/or reflexion light barrier. In particular, the head sensor can be embodied as an infrared sensor. In particular, the head sensor can be embodied opto-electrically.

In this case, the passing recognition system can comprise further components, in particular an identification reader and/or a ticket reader and/or in particular a mechanically operated manlock and/or a door.

Preferably, the detection area of the head sensor is detectable through an area of the housing, which is transparent for the head sensor. In this case, the transparent area is transparent for the detecting rays of the sensor. In particular, the transparent area can be embodied for non-visible light, in particular for infrared radiation and/or UV-radiation, transparently and/or non-transparently for visible light. Thereby, the detection area is detected through the transparent area. In this case, the rest of the housing can be non-transparently embodied. In this case, in particular partially or completely, the transparent area can be embodied uni-directionally or bi-directionally. In particular, the transparent area can be embodied such that the area is not translucent for the human eye.

In particular in this case, the head sensor can be disposed in or at the housing. In particular, the housing can have an upper wall and/or a sidewall, wherein the transparent area can be disposed in the upper wall or in the sidewall.

Preferably, the passing recognition system has a handrail. In particular, the head sensor and/or the transparent area can be disposed in the handrail. In this case, the handrail can be embodied as the upper housing part and/or delimit the housing to the top. In particular, the transparent area can be disposed in a top side or in a sidewall of the handrail. Such a handrail can be modularly installed in newer housings as the upper housing part or even as well in existing housings.

Preferably, the head sensor is able to generate a digital or serial message. In other words, the head sensor is formed such that it is able to generate and/or to transmit a digital or serial message from the detected detection data thereof. In particular, the head sensor can transmit the detection data thereof, in particular by means of a transmitter, in particular wirelessly, to a bus system, in particular CAN-bus system, or directly to a computing unit, in particular to a receiver of the computing unit. In particular, the head sensor can be embodied opto-electrically.

Preferably, the head sensor is formed as a reflexion sensor. As a reflexion sensor, the head sensor detects the detection area thereof by means of reflexion. Thus, such a sensor does not require a two-part embodiment of transmitter and receiver, but can be embodied in one part. Hereby being able to reduce the overall height of the housing and/or of the passing recognition system.

Preferably, at least one first sensor strip is disposed extending along a vertical vector and having several sensors, wherein, in the installation state thereof, the first sensor strip extend at maximum up to a height of 1300 mm, preferably 1200 mm, particularly preferred 1100 mm, in particular preferred 1000 mm, starting at the floor edge of the passing recognition system. In this case, in particular, the first sensor strip can extend at maximum up to a height of 950 mm, in particular 900 mm, in particular 850 mm, in particular 800 mm, starting at a floor edge of the passing recognition system. In particular in this case, the first sensor strip can be disposed in or at the housing or in one or at a further housing. The housing and/or the passing recognition system, based on the maximum height of the first sensor strip, can be relatively low, in particular half-high, and do/es not have to be embodied man-high.

In other words, in the installation state thereof, the first sensor strip extends at maximum up to a height of 1300 mm, in particular 1200 mm, in particular 1100 mm, in particular 1000 mm, in particular 900 mm, in particular 850 mm, in particular 800 mm, starting at the floor of the passing area to be monitored. In this case in particular, the floor edge forms the floor-sided termination of the passing recognition system.

Disposing the sensors along a vertical vector means that the sensors are disposed along a line, wherein the line includes at least one vertical component. Preferably, the sensors are disposed along the vertical vector, wherein the vertical component of the vector amounts at least for 80, in particular 90, in particular 95, in particular 99 percent of the vector. In particular, the sensors of the first sensor strip can be disposed offset on a vertically extending plane or along the vertical vector. In particular in this case, the first sensor strip can extend at minimum from a height of 1 mm, in particular 5 mm, in particular 10 mm, in particular 15 mm, in particular 20 mm, in particular 25 mm, in particular 30 mm, at maximum up the indicated height starting at the floor edge of the passing recognition system.

In particular in this case, the detection area of the first sensor strip can extend at minimum from a height of 1 mm, in particular 5 mm, in particular 10 mm, in particular 15 mm, in particular 20 mm, in particular 25 mm, in particular 30 mm, and at maximum up to a height of 1300 mm, preferably 1200 mm, preferably 1100 mm, preferably 1000 mm, particularly preferred 900 mm, particularly preferred 850 mm, particularly preferred 800 mm, starting at the floor edge of the passing recognition system. In particular, the rays of the sensor strip can extend vertically to the vertical vector.

For the detection thereof, a single sensor can have at least one source and at least one receiver and/or detect the detection area thereof by reflexion. In particular, a single sensor can be formed as an optical and/or opto-electronical and/or photo-electric sensor. In particular in this case, cameras, in particular photo cameras and/or video cameras, can be excluded as sensors. In particular, a single sensor can be formed as a light barrier and/or one-way light barrier and/or reflexion light barrier and/or infrared light barrier. A sensor strip can be formed as a unit of several assembled and/or interconnected sensors, in particular on a printed circuit board. As an alternative, a sensor strip can be formed from several single sensors, in particular with respective distinct line and/or distinct data channel, wherein, in the installation state thereof, the single sensors extend along the vertical vector. The distance between the sensors of the sensor strip can be always the same or vary from sensor to sensor. In this case, at least one distance, in particular each distance between two sensors can be between 5 mm and 50 mm, in particular between 10 mm and 45 mm, in particular between 15 mm and 40 mm, in particular between 20 mm and 35 mm, in particular between 25 mm and 30 mm. In particular, the first sensor strip can have from 2 to 60, in particular from 5 to 50, in particular from 10 to 40, in particular from 15 to 30, in particular 20 to 25 sensors, in particular 24 sensors, in particular 28 sensors.

According to a further development of the present disclosure, at least the first sensor strip includes at least one strip head in particular comprising several of the upper sensors, and a strip body comprising at least one sensor, in particular several sensors, below the strip head. The strip head and/or the strip body can be formed respectively as a unit from several assembled and/or interconnected sensors. As an alternative, the strip head and/or the strip body can be formed from several single sensors, in particular with respective distinct line and/or distinct data channel, wherein, in the installation state, the strip head and the strip body extend along the vertical vector. In particular, the strip head can extend at minimum from a height of 600 mm, in particular 650 mm, in particular 700 mm, in particular 800 mm, in particular 850 mm, in particular 900 mm, and/or at maximum up to a height of 1300 mm, in particular 1200 mm, in particular 1100 mm, in particular 1000 mm, in particular 900 mm, in particular 850 mm, in particular 800 mm, starting at the floor edge of the passing recognition system. In particular, the strip head and/or the strip body can comprise respectively several sensors. In particular, the strip head can comprise from 2 to 30, in particular from 4 to 25, in particular from 5 to 20, in particular from 10 to 15, in particular 3 sensors. In particular, the strip body can comprise from 2 to 60, in particular from 5 to 50, in particular from 10 to 40, in particular from 15 to 30, in particular from 20 to 25, in particular 20, in particular 24 sensors.

Preferably, the passing recognition system comprises a second sensor strip including at least one sensor, in particular several sensors, wherein the second sensor strip is disposed next to the first sensor strip, in particular parallel to the first sensor strip, wherein the second sensor strip has fewer sensors than the first sensor strip, and/or wherein the second sensor strip is formed shorter than the first sensor strip and/or the second sensor strip extends beyond the height of the strip head of the first sensor strip. In this case, the detection area of the sensors is meant to be next to the first sensor strip. This means, the detection areas of both sensor strips are located next to each other. In particular in this case, the two sensor strips can be disposed on a virtual plane. In particular, the second sensor strip can extend along a vertical vector. In particular, the second sensor strip can have from 2 to 30, in particular from 3 to 25, in particular from 4 to 20, in particular from 5 to 15, in particular 8 to 10 sensors. In particular, the second sensor strip can likewise extend along a vertical vector, the vertical component thereof amounting for 80 to 100, in particular for 90 to 95 percent of the vector. In particular, the second sensor strip can extend at minimum from a height of 5 mm, in particular 10 mm, in particular 100 mm, in particular 400 mm, in particular 800 mm and/or at maximum up a height of the first sensor strip starting at the floor edge. Preferably, the second sensor strip can extend at least beyond the height of the strip head of the first sensor strip.

The above-described possibilities of the embodiment of the first sensor strip as well as the individual sensors thereof, in particular with regard to the detection and/or the design and/or the distance and/or the transmission of the states of motion are correspondingly valid for the second sensor strip.

Preferably, a third sensor strip with at least one sensor, in particular at least two sensors is disposed, in particular extending underneath the first sensor strip along a horizontal vector. Disposing the sensors along the horizontal vector means that the sensors are disposed along a line, wherein the line includes at least one horizontal component. Preferably, the sensors are disposed along the horizontal vector, wherein the horizontal component amounts at least for 80 to 99, in particular for 85 to 95 percent of the vector. In particular, the sensors of the first sensor strip can be disposed offset on a vertically extending plane or along the horizontal vector.

In particular, the third sensor strip can be disposed at a height of 3 to 250 mm, in particular of 5 to 200 mm, in particular of 15 to 165 mm, in particular of 25 to 150 mm, in particular of 30 to 100 mm, in particular of 40 to 50 mm, starting at the floor edge of the passing recognition system and/or starting at the floor of the passing area. In particular, the third sensor strip can comprise from 2 to 50, from 3 to 40, from 5 to 30, from 10 to 21 sensors.

The above-described possibilities of embodying the sensor strip as well as the individual sensors thereof, in particular with regard to the detection and/or the design and/or the distance and/or the transmission of the motion states are correspondingly valid for the third sensor strip.

In particular, the passing recognition system can include at least one mechanical barrier for blocking the passing area. In particular, when disposing a mechanical barrier, the third sensor strip can thereby extend over a passing area locally in front of and/or after the barrier. In this manner, it can be reliably determined whether or not an individual and/or an object has actually passed the barrier.

Preferably, the passing recognition system comprises at least one computing unit for processing at least one message of at least one sensor, in particular of several sensors, in particular of all sensors.

Flagging as active the respective sensor occurs, if said sensor detects something within the detection area thereof and flagging as passive the respective sensor occurs, if said sensor detects nothing within the detection area thereof. If a certain sensor is flagged as active and another sensor is not, automatically, the other sensor can be flagged as passive or vice versa. In other word, the message can be understood as status state of the respective sensor. The message can be digital or serial. In particular, the message can be realized in the context of a data set, in particular 0 or 1, or in the context of an applied and/or not applied voltage with regard to the respective sensor, depending on whether or not the respective sensor detects something or nothing. The computing unit is able to process, in particular evaluate the at least one message of the at least one sensor.

In particular, the passing recognition system can comprise a device, in particular a camera, for biometric recognition, in particular facial recognition.

According to a further aspect of the present disclosure, is indicated a method for non-contact monitoring of at least one sequence of motions including several states of motions by means of an inventive passing recognition system with a computing unit, wherein the head sensor detects at least one first state of motion above the housing, and transmits it to the computing unit.

In the context of the disclosure, a state of motion is understood as a snapshot of the detected passing area by at least one sensor of the passing recognition system, in particular the head sensor. Thus, visually explained, a state of motion indicates, which sensors detect something, for example in the form of a newly recognized object and/or an individual in the respective detection area at a discrete point in time.

The method, by means of passing recognition system having a relatively low height, allows for detecting and processing, in particular evaluating motion data above at least the housing of the passing recognition system. This can improve the reliability of the method. Thus, in particular being able to improve the view in the area of such embodied systems. Furthermore, allowing for respecting design requirements, which prefer the half-high structure of such systems. Moreover, passing individuals are more at ease when passing, because they feel less constricted.

In particular, a bus, in particular a CAN-bus can transmit the at least one state of motion. In particular, the at least one state of motion can be transmitted serially and/or digitally and/or wirelessly to the computing unit.

Preferably, the method comprises the following steps:
flagging as active the respective sensor, if said sensor detects something within the detection area thereof and flagging as passive the respective sensor, if said sensor detects nothing within the detection area thereof,
detecting at least the first state of motion and at least one second state of motion by at least the head sensor, in particular by several sensors, by means of the messages at least of the head sensor, wherein the first state of motion and the second state of motion are detected at discrete points in time, which follow each other respectively indirectly or directly,
transmitting the states of motion to the computing unit,
the computing unit recognizing at least one sequence of motions based on the transmitted states of motion.

In this case, a sequence of motions means walking through and/or passing the detection area at least of the first sensor strip. In particular, a sequence of motions can be recognized based on the comparison over time of states of motion. In particular, with further sensors being arranged, a single state of motion can likewise comprise the snapshot of the further sensors at the same point in time of the snapshot of the head sensor.

In this case, the first state of motion does not necessarily have to be the very first state of motion of the respective sequence of motions. It is just significant that the second state of motion is detected chronologically after the first state of motion.

Obviously In this case, the transmission of the detected first state of motion to the computing unit can be realized temporally following the detection of the first state of motion, whereupon then only the second state of motion is detected and then transmitted to the computing unit. Thus, it is not mandatory that initially several states of motion are detected and only temporally thereafter are transmitted to the computing unit, but any single state of motion can be detected and transmitted. In particular in this case, a state of motion can be filtered, which compared to the directly preceding state of motion does not deviate in terms of the messages of the sensors. This means, such a state of motion would not be transmitted in this case to the computing unit or would not be considered by the computing unit.

The method allows for reliably recognizing the sequences of motion at a relatively low embodiment of the passing recognition system. Thus, in particular being able to improve the view in the area of such embodied systems. Furthermore, allowing for respecting design requirements, which prefer a half-high structure of such systems. Moreover, passing individuals are more at ease when passing, because they feel less constricted. Advantageously, with high precision and also at little distance between two individuals following each other or other mobile objects such a configured inventive method allows for recognizing the respective sequence of motions.

Particularly when performing an access control, an identification reader and/or ticket reader can be disposed. Generally in particular in this case, it can be required to allow the access just for a single individual, potentially with one or more objects, in a single successfully performed access control and/or to document abuses of said rule.

As an alternative or cumulatively however, the disclosure can be applied just for counting individuals and/or objects passing the passing area.

The computing unit can control at least the head sensor, in particular with regard to the operating frequency. In particular, the computing unit can include a transmitter for transmitting the at least one detected state of motion and/or a receiver for receiving the detected states of motion and/or an evaluating unit for recognizing the sequence of motions and/or a supply unit and/or a display for illustrating the at least one state of motion and/or the sequence of motions.

Preferably, the sequence of motions is associated to at least one individual and/or at least one object. Thereby, allowing for counting passing individuals and/or objects. An item is understood as an object. In particular, the sequence of motions can be associated to at least one individual, if within the sequence of motions, the head sensor is flagged as active at least once, in particular several times. Hereby, it is assumed that just an individual causes an active flagging of the head sensor, because the detection area of the head sensor is located above the passing recognition system and, for example, items such as carry-on bags usually do not reach as far as to said detection area.

In particular, the sequence of motions can be associated to at least one individual, if, within the first state of motion, are flagged as active all sensors of the strip head of the first sensor strip and/or all sensors of the second sensor strip. Hereby, it is assumed that just an individual within a single state of motion can flag as active all sensors at the height of the strip head and/or of the second sensor strip.

In particular, the sequence of motions can be associated to at least one individual, if, within the sequence of motions, is flagged as active at least once each single sensor of the first sensor strip or each single sensor of the strip body of the first sensor strip. Hereby, providing a reliable recognition of individuals. What is meant is that, in all states of motion of the single sequence of motions, is flagged as active at least once each single sensor of the first sensor strip or each single sensor of the strip body wherein it is irrelevant, when this happens over the time of the sequence of motions. In this case, it is assumed that an individual within the sequence of motions thereof causes at least once an active flagging of each single sensor. In this case, this does not have to happen within a single state of motion, but within a single sequence of motions with all the states of motion thereof included.

In particular, the sequence of motions can be associated to at least one individual, if, within the single state of motion, is flagged as active each single sensor of the first sensor strip or each single sensor of the strip body. In particular, the sequence of motions can be associated to at least one individual, if, within the first state of motion, is flagged as active at least the topmost sensor of the first sensor strip and/or the topmost sensor of the strip body, and within the second state of motion at least the lowermost sensor of the sensor strip and/or the lowermost sensor of the strip body, wherein, within the single sequence of motions, is flagged as active at least once each single sensor of the first sensor strip or each single sensor of the strip body. In particular, the sequence of motions can be associated to at least one individual, if, within the first state of motion, is flagged as active at least the lowermost sensor of the first sensor strip and/or the lowermost sensor of the strip body and within the second state of motion at least the topmost sensor of the sensor strip and/or the topmost sensor of the strip body, wherein, within the sequence of motions, is flagged as active at least once each single sensor of the first sensor strip or each single sensor of the strip body.

In particular, the sequence of motions can be associated to at least one individual, if, with regard to the number of sensors flagged as active of the first sensor strip, in particular of the strip body of the first sensor strip, within a single state of motion, was detected at least once a positive difference and/or at least once a negative difference between the states of motion, in particular between states of motion following each other temporally indirectly or directly, within the sequence of motions. Hereby, it is assumed that, within the sequence of motions, at least once during the temporally progressing sequence an individual causes an increasing number and/or at least once during the temporally progressing sequence a decreasing number of active sensors of the first sensor strip, in particular of the strip body of the first sensor strip. This allows for a reliable recognition of a typical gait of an individual. However usually, an upright-guided carry-on bag causes a constant number of active sensors over the time. In this manner, upright-guided carry-ons can be reliably recognized, exactly not as individuals.

Preferably, the recognition of the sequence of motions comprises delimiting the sequence of motions from a further sequence of motions based on a separation criterion. This allows for distinguishing a passing individual and/or a passing object from a next individual and/or a next object and thus to count the individuals and/or objects.

In particular, the separation criterion can intervene, if the head sensor, at least in the first state of motion, in particular in several states of motion directly following each other, is flagged as active and as passive at least in a second state of motion, in particular in several states of motion directly following each other.

The separation criterion intervening is understood as delimiting a sequence of motions from another sequence of motions. In particular in this case, the second state of motion can be taken already at least as one of the states of motion of the further sequence of motions.

In particular, the separation criterion can intervene, if a certain difference is determined between the number of the sensors flagged as active of the first sensor strip, in particular of the strip head, in particular of the strip body, within the first state of motion, and the number of the sensors flagged as active of the first sensor strip, in particular of the strip head, in particular of the strip body, within the second state of motion.

In particular, the separation criterion can intervene at a difference of at least two to twenty, in particular three to fifteen, in particular four to twelve, in particular five to ten active sensors.

In particular, the separation criterion can intervene, if, within a single state of motion, a certain difference is determined between the number of the sensors flagged as active of the first sensor strip, in particular of the strip head, and the number of the sensors flagged as active of the second sensor strip.

In particular, the separation criterion can intervene at a difference of at least two to ten, in particular three, in particular four, in particular five active sensors.

Such a separation criterion allows for a reliable separation between sequences of motions of single individuals or objects. In particular, it allows for reliably singling individuals, even with individuals following each other closely.

As an alternative or cumulatively, the recognition of the sequence of motions can comprise a delimitation of the sequence of motions from a further sequence of motions based on a separation criterion, wherein the separation criterion intervenes, if, within the first state of motion, are flagged as active at least one of the sensors, in particular a certain number of sensors, in particular all sensors of the strip head and/or of the strip body, wherein, within the second state of motion, are flagged as passive at least one of the sensors, in particular a certain number of sensors, in particular all sensors of the strip head and/or of the strip body.

In particular, the first state of motion can be filtered, if the first state of motion includes a number of up to three, preferably two, particularly preferred one sensor flagged as active of the sensor strip, in particular of the first sensor strip, in particular within the strip body and, in one or more states of motion respectively directly following thereafter, said number of sensors flagged as active increases by less than three, in particular two. Such filtering reduces the data flow rate. This means, such a state of motion is not considered for recognizing a sequence of motions. Such states of motion are caused for example by small items, such as bag belts or telescopic tubes of carry-ons held obliquely, and can be disregarded in the method.

As an alternative or cumulatively, single states of motion can be filtered, which do not change with regard to directly following point in time.

In particular, recognizing the sequence of motions can comprise recognizing a direction of the sequence of motions and/or recognizing a turn with the help of a second sensor strip including at least one sensor, in particular several sensors, wherein the second sensor strip is disposed next to the first sensor strip, in particular parallel to the first sensor strip. Recognizing the direction can be realized in that, during a sequence of motions in the direction of the first sensor strip in an first state of motion, are flagged as active the sensors, in particular a certain number of sensors, in particular all sensors of the second sensor strip, and temporally thereafter, in a second state of motion, are flagged as active the sensors, in particular a certain number of sensors, in particular all sensors of the strip head of the first sensor strip.

In particular in a realized passage, in a further state of motion following thereafter, are flagged as passive at first the sensors, in particular a certain number of sensors, in particular all sensors of the second sensor strip, and then in yet another state of motion following thereafter, are flagged as passive the sensors, in particular a certain number of sensors, in particular all sensors of the strip head, of the first sensor strip. Unlike in a passage, in a turn within the detection area of the sensor strips, which corresponds to an abortion of the passage, in the further state of motion following thereafter, are flagged as passive at first the sensors, in particular a certain number of sensors, in particular all sensors of the strip head of the first sensor strip, and then in the further state of motion following yet thereafter, are flagged as passive the sensors, in particular a certain number of sensors, in particular all sensors, of the second sensor strip.

In a sequence of motions in the direction of the second sensor strip the opposite is respectively valid. Thus, the direction and/or the turn of the sequence of motions can be reliably recognized. Therefore, the passing recognition system can be performed for passing in both directions.

In particular, detecting the at least one state of motion can comprise a determination of a number of sensors flagged as active and/or as passive, in particular within the first sensor strip, in particular within the strip head and/or the strip body of the first sensor strip and/or within the second sensor strip. Such determination represents useful information for the reliable recognition of the sequence of motions. In particular, such detection can be realized within each state of motion.

In particular, foot recognition of an individual can be realized with the third sensor strip. In particular, recognizing the sequence of motions can comprise foot recognition of an individual, wherein the sequence of motions can be associated to a foot of an individual, if, at a certain discrete point in time, is flagged as active a certain number, in particular of the lower sensors, of the strip body of the first sensor strip, and simultaneously are flagged as active at least the one sensor, in particular the at least two sensors of the third sensor strip, wherein the at least one sensor of the third sensor strip is disposed in the direction of the sequence of motions behind the first sensor strip.

In this case in particular, the first sensor strip, in the installation state thereof, can extend at maximum up to a height of 600 mm, preferably 500 mm, particularly preferred 400 mm, in particular preferred 300 mm, starting at the floor edge of the passing recognition system. Also in such low-level embodiment of the first sensor strip, the states of motion can be nevertheless sufficient for the foot recognition of an individual, as for this purpose just the lower area of the leg of an individual is decisive.

In particular, the sequence of motions can be associated to an individual, if the sequence of motions is associated to a foot of an individual.

As an alternative or cumulatively to the second sensor strip, the third sensor strip can realize a direction recognition of the sequence of motions. In particular in this case, recognizing the direction of motion of the sequence of motions can be realized in that at least one first sensor of the third sensor strip and a second sensor of the third sensor strip in the direction of motion are disposed next to the first sensor, and are flagged as active within the sequence of motions, wherein the second sensor is flagged as active at a later point in time than the first sensor.

In particular, the states of motion can be converted by means of a conversion unit prior to and/or after transmission to the computing unit. In particular, the states of motion can be illustrated by means of a display of the computing unit and/or an additional display of the passing recognition system.

According to a further aspect of the disclosure, the inventive method is performed computer-implemented, wherein the computing unit and/or an additional computer form/s the computer.

In particular for this purpose, a computer program on a data carrier can be employed for performing the method. In particular in this case, at least one step, in particular several steps, in particular all steps of the method can be performed by means of an algorithm running on the computer.

### BRIEF DESCRIPTION OF THE DRAWINGS

Further details and advantages of the disclosure will be explained in the following based on exemplary embodiments partially diagrammatically shown in the Figures. The same reference numerals respectively identify elements having the same function and manner of operation. It shows:

FIG. 1 a perspective view of a first exemplary embodiment of an inventive passing recognition system;

FIG. 2 a flow diagram of an embodiment of an inventive method;

FIG. 3 a lateral view of a housing with the first as well as the second sensor strip;

FIG. 4a a first illustration of a sequence of motions based on a plurality of detected states of motion;

FIG. 4b a second illustration of a sequence of motions based on a plurality of detected states of motion;

FIG. 5a an illustration of a direction recognition;

FIG. 5b an illustration of a turn recognition;

FIG. 6 a third illustration based on a plurality of detected states of motion; and

FIG. 7 a fourth illustration of a sequence of motions based on a plurality of detected states of motion.

### DETAILED DESCRIPTION OF THE DRAWINGS

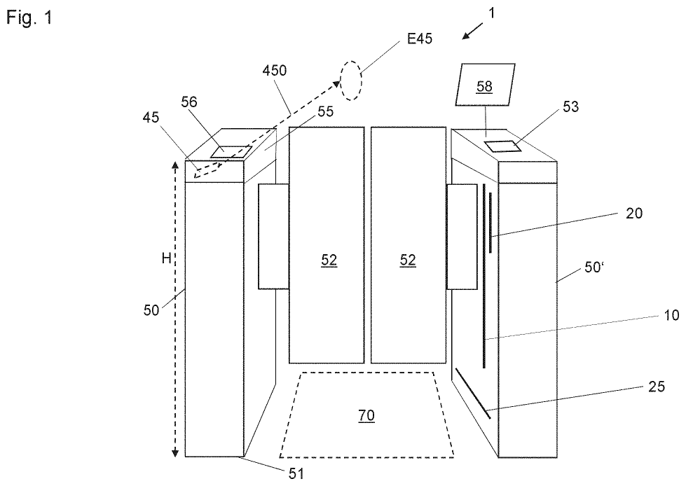

FIG. 1 shows a view of a first embodiment of an inventive passing recognition system 1 with a scanner 53, two displaceable doors 52, a passing status display 58 and a head sensor 45 for detecting a detection area E45 above a housing 50 and a further housing 50′. In this case, the head sensor 45 is disposed in a handrail 55, which is disposed as an upper part of the housing 50, and thereby detects the detection area E45 thereof through an area of the handrail 55, which is transparent for the head sensor 45. In this case, the arrow 450 represents the detection direction of the head sensor 45 extending obliquely upwards. The detection area E45 is located above the housings 50, 50′ respectively with the height H and above 1200 mm starting at the floor 70 of the passing area and starting at a floor edge 51 of the housing 50. In this case, the head sensor 45 is oriented obliquely upwards. Hereby, motions are detectable, which occur above at least of the housings 50, 50′, In this case, a first sensor strip 10, a second sensor strip 20, and a third sensor strip 35 are disposed at the housing 50′ and diagrammatically illustrated.

Such a passing recognition system allows for reliably recognizing individuals with simultaneous low-level embodiment of the housings 50, 50′ and/or the passing recognition system 1.

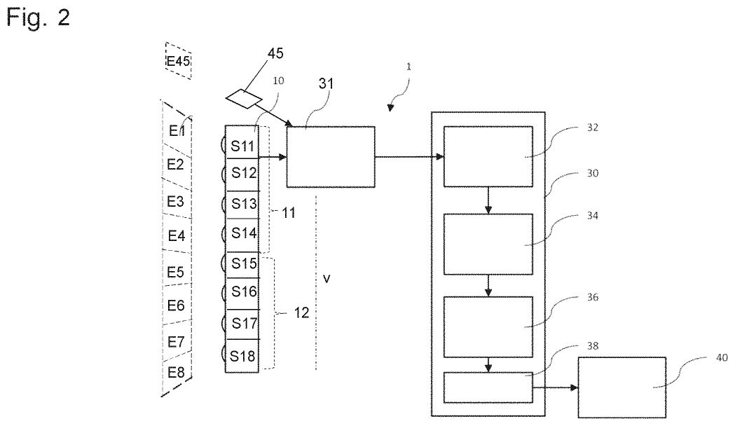

FIG. 2 shows a flow diagram of an inventive method with a passing recognition system 1, comprising a head sensor 45 for detecting the detection area E45, the first sensor strip 10 with the sensors S11 to S18 for detecting states of motion 2 within a detection area E1 to E8, a transmitter 31 for transmitting the states of motion, a computing unit 30 with a receiver 32 for receiving the states of motion 2, with an evaluation unit 34 for evaluating the states of motion, with a supply unit 36 for supplying the states of motion 2, with a conversion unit 38 for converting the states of motion 2 and with a display 40 of a recognized sequence of motions 4. In this case, the first sensor strip 10 extends along the vertical vector v, wherein the vertical component thereof amounts to 100 percent. The first sensor strip 10 is divided into a strip head 11 with the upper four sensors S11 to S14 and an exemplary strip body 12 with the lower four sensors S15 to S18. In this case, the head sensor 45 is oriented obliquely upwards.

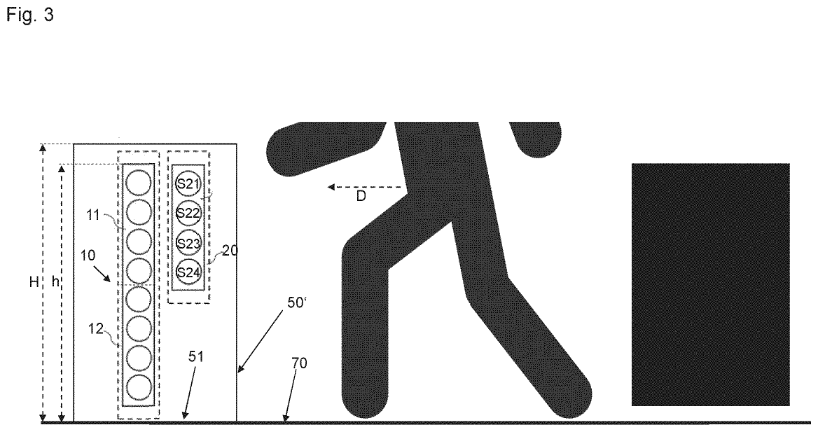

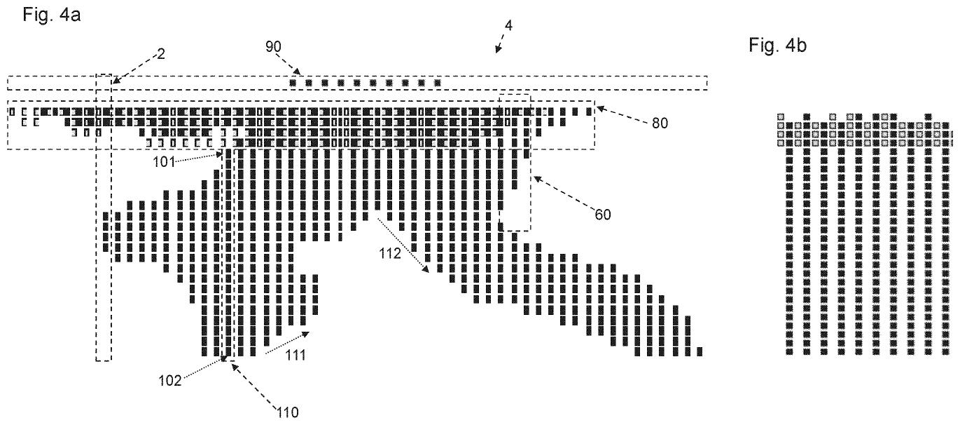

FIG. 3 shows a lateral view of the further housing 50′ of the passing recognition system with the first sensor strip 10 and, disposed parallel to the first sensor strip 10, the second sensor strip 20 with the sensors S21 to S24 thereof and with the floor edge 51. The floor edge 51 is set on the floor 70 of the passing area. The first sensor strip 10 extends up to a height h starting at the floor edge 51. Simultaneously, the first sensor strip 10 extends up to a height h starting at the floor 70 of the passing area. Furthermore are illustrated an individual and an upright guided bag moving in the direction D. The number of sensors, the length as well as the installation height of the second sensor strip 20 correspond to the strip head 11 of the first sensor strip 10. The housing 50′ has an overall height H. The second sensor strip 10 serves for an exemplary complementary detection of states of motion 2, in order to allow the computing unit 30 for evaluating the direction of the recognized sequences of motions 4. This is explained in more detail based on FIG. 4a and FIG. 4b.

FIG. 4a shows a plurality of states of motion 2 of an individual, who, according to FIGS. 1 and 3, passes the passing recognition system 1. The black filled squares symbolize sensors of the head sensor 45 and of the first sensor strip 10 flagged as active, herein, differing from FIG. 3, with altogether 24 sensors. The non-filled or grey filled squares symbolize sensors flagged as active of the second sensor strip 20 with altogether four sensors. The empty spots symbolize sensors flagged as passive of the head sensor 45, of the first sensor strip 10 and of the second sensor strip 20. Each column represents a detected state of motion 2. The plurality of columns results from the temporal progress of the detected states of motion 2, respectively detected by the head sensor 45, the first sensor strip 10 and the second sensor strip 20, chronologically from left to right. Each row represents the detection of the head sensor 45 and of respectively one sensor of the sensor strips 10, 20 over the time from left to right. The topmost row 90 shows the detection of the head sensor 45. The four rows 80 show respectively the detected states of motion 2 of the sensors of the strip head 11 of the first sensor strip 10 and of the second sensor strip 20. The lower 20 rows show respectively the detected states of motion 2 of the sensors of the strip body 12 of the first sensor strip 10, wherein, differing from FIG. 3, the strip body 12 includes twenty sensors.

Line 90 shows that the head sensor 45 is flagged as active in several consecutive states of motion 2. This results in associating the sequence of motions 4 to an individual.

Furthermore, in a state of motion 110, all sensors of the strip body are flagged as active at least once, wherein furthermore are flagged as active both the topmost sensor in 101 and the lowermost sensor in 102. Furthermore in the following, a positive difference is determined between the states of motion over the time within the sequence of motions 4, namely a decreasing number of active sensors of the strip body 12, which the arrow 111 indicates. Furthermore in the following, a negative difference is determined between the states of motion, namely an increasing number of active sensors of the strip body 12 over the time within the sequence of motions 4, which the arrow 112 indicates. Moreover, temporally prior to the state of motion 110, is determined already an increase in active sensors of the strip body 12. These are further confirmed conditions for associating the sequence of motions 4 to an individual.

Furthermore, is illustrated in an area 60, when a separation criterion according to the inventive method intervenes and thus delimits a sequence of motions 4 from a further sequence of motions. In the area 60 are flagged as passive both single sensors of the strip head 11 and of the second sensor strip 20 and also single sensors of the strip body 12 as well as also of the head sensor 45. This results in the separation criterion intervening, and therefore, the sequence of motions 4 is deemed as terminated.

Unlike FIG. 4a, FIG. 4b illustrates states of motion of an upright guided bag, according to FIG. 3, right side. Herein, differing from FIG. 4a, no active flagging of the head sensor and no differences in the number of sensors of the strip body 12 flagged as active between the states of motion are determined within the sequence of motions over the time. Therefore, this sequence of motions is not associated to an individual, but to an object, for example.

Thus, the inventive method and the inventive passing recognition system allow for reliably recognizing individuals with simultaneous low-level embodiment of the passing recognition system.

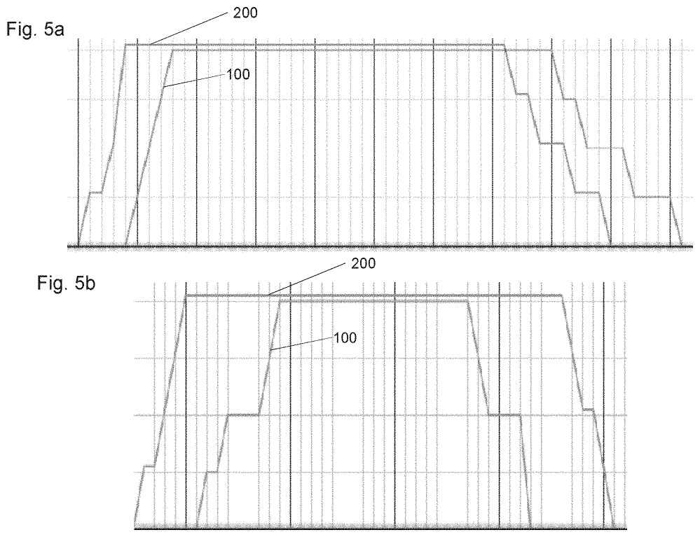

FIG. 5a illustrates the temporal progress of the number of active sensors of the four rows 80 according to FIG. 4a. The progress 100 corresponds to the strip head 11 of the first sensor strip 10 and the progress 200 corresponds to the second sensor strip 20. Initially in the first step, are flagged as active all four sensors of the second sensor strip 20, and temporally thereafter all four sensors of the strip head 11. Initially, in the second step are flagged as passive all sensors of the second sensor strip 20, and temporally thereafter all sensors of the strip head 11 of the first sensor strip 10. This results in recognizing the direction D of the sequence of motions as illustrated in FIG. 3 from right to left.

In contrast thereto, FIG. 5b illustrates a turn of the sequence of motions, wherein, unlike described previously with regard to FIG. 5a, in the second step initially are flagged as passive all sensors of the strip head 11 of the first sensor strip 10 and temporally thereafter all sensors of the second sensor strip 20. This results in recognizing a turn of the sequence of motions.

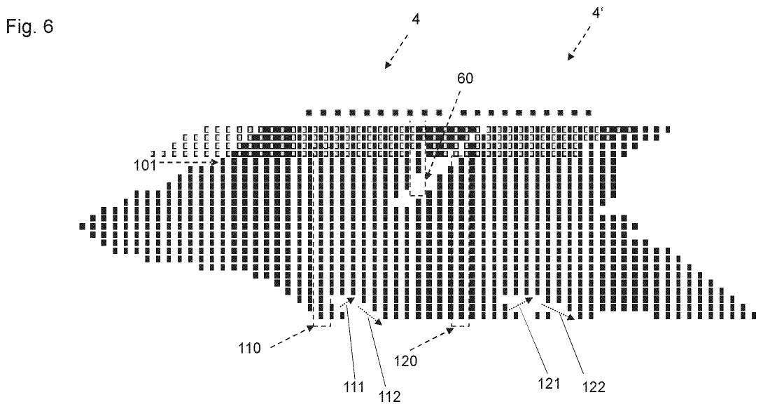

FIG. 6 shows a plurality of states of motion 2 of an individual and of a further individual following each other closely. Essentially, associating the sequence of motions 4 to an individual is realized analogously to FIG. 4a. The head sensor 45 flagged as active, all sensors of the strip body 12 in 110 flagged as active, the decreasing number of active sensors of the strip body 12 according to arrow 111, as well as the increasing number of active sensors of the strip body 12 according to arrow 112 result herein in associating the sequence of motions 4 to an individual. In the area 60, are flagged as passive both single sensors of the strip head 11 as well as of the second sensor strip 20 and also single sensors of the strip body 12. This results in the separation criterion intervening, and therefore, the sequence of motions 4 is deemed as terminated, wherein simultaneously the next sequence of motions 4′ starts. The head sensor 45 flagged as active, all sensors of the strip body 12 in 120 flagged as active, the decreasing number of active sensors of the strip body 12 according to arrow 121, as well as the increasing number of active sensors of the strip body 12 according to arrow 122 herein likewise result in associating the sequence of motions 4′ to an individual.

Thus, the inventive method and the inventive passing recognition system allow for reliably recognizing single individuals with simultaneous low-level embodiment of the passing recognition system 1 and for individuals following each other closely.

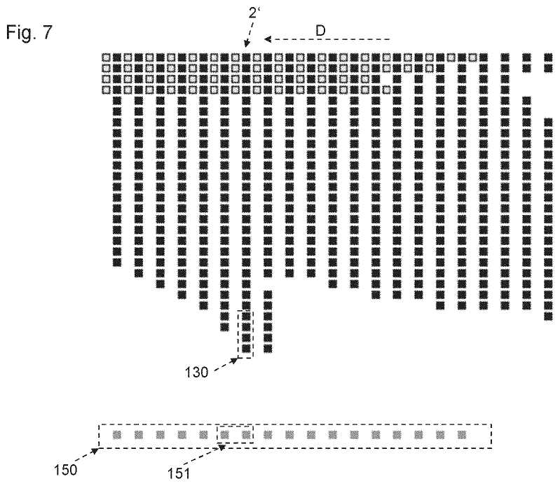

FIG. 7 shows a plurality of states of motion 2 of an individual with a sequence of motions from right to left according to FIG. 3, which the passing recognition system 1 according to FIG. 1 detects. In this case, the area 150 depicts a single state of motion, which the third sensor strip 25 detects, however, within the single state of motion 2′. In this state of motion 2′, are flagged as active the four lower sensors of the sensor strip 12, illustrated by area 130. Simultaneously, in the discrete point in time of the state of motion 2′, are flagged as active two sensors, illustrated by area 151, wherein the one sensor is located locally below the first sensor strip 10 and the second one behind the first sensor strip 10 in the direction of motion D. In this case, the direction of motion is recognized analogously to the explanation of FIG. 5, so that it can be deduced, which one of the sensors of the third sensor strip is located behind the first sensor strip 10. Thereby, the illustrated sequence of motions is associated to a foot of an individual and thus to an individual.

Thus, the inventive method and the inventive passing recognition system allow for reliably recognizing single individuals with simultaneous low-level embodiment of the passing recognition system 1 and for individuals following each other closely.

1. A passing recognition system for non-contact monitoring of a passing area comprising: at least one housing, a floor edge, configured for installing on a floor of the passing area, and with a head sensor configured for detecting a detection area wherein the detection area of the head sensor is located above the housing.

2. The passing recognition system according to claim 1, wherein the detection area of the head sensor is detectable through an area of the housing, which is transparent for the head sensor.

3. The passing recognition system according to claim 1, wherein the passing recognition system includes a handrail, wherein the head sensor is disposed in the handrail and/or in that the transparent area is disposed in the handrail.

4. The passing recognition system according to claim 1, wherein the head sensor is able to generate a digital message or a serial message.

5. The passing recognition system according to claim 1, wherein the head sensor is formed as a reflexion sensor.

6. The passing recognition system according to claim 1, wherein a first sensor strip is disposed extending along a vertical vector and including several sensors, wherein, in an installation state, the first sensor strip extends at maximum up to a height of 1300 mm, starting at the floor edge of the passing recognition system.

7. The passing recognition system according to claim 6, wherein at least the first sensor strip includes a strip head comprising at least one upper sensors, and, below the strip head, a strip body comprising at least one sensor.

8. The passing recognition system according to claim 6, wherein the passing recognition system comprises a second sensor strip including at least one sensor, wherein the second sensor strip is disposed next to the first sensor strip, parallel to the first sensor strip, wherein the second sensor strip has fewer sensors than the first sensor strip, and/or wherein the second sensor strip is formed shorter than the first sensor strip and/or the second sensor strip extends beyond the height of the strip head of the first sensor strip.

9. The passing recognition system according to claim 1, wherein extending underneath the first sensor strip along a horizontal vector, a third sensor strip is disposed with at least one sensor.

10. The passing recognition system according to claim 1, wherein the passing recognition system comprises at least one computing unit for processing at least one message of at least one sensor.

11. A method for non-contact monitoring of at least one sequence of motions having several states of motion by a passing recognition system comprising at least one housing, a floor edge, configured for installing on a floor of the passing area, and with a head sensor configured for detecting a detection area wherein the detection area of the head sensor is located above the housing, with a computing unit, wherein the head sensor detects at least one first state of motion above the housing and is transmitted to the computing unit.

12. The method according to claim 11, wherein the method comprises further includes the following steps:
flagging as active the respective sensor, if said sensor detects something within the detection area thereof and flagging as passive the respective sensor, if said sensor detects nothing within the detection area thereof,
detecting at least the first state of motion and at least one second state of motion with the messages of at least the head sensor, wherein the first state of motion and the second state of motion are detected at discrete points in time, which follow each other respectively indirectly or directly,
transmitting the states of motion to the computing unit, and
the computing unit recognizing at least one sequence of motions based on the transmitted states of motion.

13. The method according to claim 1, wherein the sequence of motions is associated to at least one individual and/or at least one object, wherein the sequence of motions is associated to at least one individual, if, within the sequence of motions, the head sensor is flagged as active at least once, in particular several times.

14. The method according to claim 1, wherein recognizing the sequence of motions comprises delimiting the sequence of motions from a further sequence of motions based on a separation criterion, wherein the separation criterion intervenes, if the head sensor is flagged as active at least in the first state of motion and is flagged as passive at least in a second state of motion.

15. A computer-implemented method according to claim 11, wherein the computing unit and/or an additional computer form/s the computer.
